(19) United States
(12) Patent Application Publication
(10) Pub. No.: US 2013/0139206 A1
(43) Pub. Date: May 30, 2013

(54) TRANSMISSION METHOD FOR PUSH TYPE VIDEO ON DEMAND PROGRAMS AND ASSOCIATED DECODER

(71) Applicants: Christian Benardeau, Bussy Saint Georges (FR); Thierry Lelegard, Paris (FR)

(72) Inventors: Christian Benardeau, Bussy Saint Georges (FR); Thierry Lelegard, Paris (FR)

(73) Assignee: LOGIWAYS FRANCE, Paris (FR)

(21) Appl. No.: 13/398,322

(22) Filed: Feb. 16, 2012

(30) Foreign Application Priority Data
Nov. 24, 2011 (FR) 1160759

(51) Int. Cl. H04N 21/25

(52) U.S. Cl. 725/93; 725/100

(57) ABSTRACT

Transmission method for VOD “Push” programs, comprising the steps of: transmission of a stream containing VOD “Push” programs from a remote server over a broadcasting network to a destination of multiple decoders, storage of program units in the memory by each decoder; the stream containing a first program unit comprising a first audio/video content, a second program unit comprising a second audio/video content, and a third program unit comprising a list containing at least the identifiers of the first and second units, according to which, when the decoder receives a command for playing the third program unit, it proceeds to displaying on the screen successively the first and the second audio/video contents, depending on the data present in a field of metadata of the third program unit.

### CROSS REFERENCE TO RELATED APPLICATIONS

This patent application claims priority to French patent application no. FR1160759, filed Nov. 24, 2011, the disclosure of which is herein incorporated by reference in its entirety.

### BACKGROUND

The present invention relates to a transmission method for Push type video on demand programs comprising the steps according to which:

a broadcasting stream of Push type video on demand program units is transmitted from a remote server over a broadcasting network to multiple decoders connectable to display screens, with each program unit comprising at least a first corresponding metadata field containing a unit identifier and, optionally, a second field with audio/video content,

the program units are stored in the memory of each decoder.

There are three types of services of video on demand, hereinafter referred to as VoD, provided between a streaming server and a decoder connected to a TV screen which receives a video transmitted from the streaming server to a broadcasting network, for example a Hertzian one.

In the live VoD service, the user selects a content and watches it, while his set-top box receives it from a remote service-provider server. This is a “streaming” to a particular user who has selected this content. The user can select instructions of the type “pause”, “stop”, “back”, “view from the beginning”, “jump forward”, etc. Each one of these instructions is sent to the server which adapts the streamed content in teal time depending on the received instructions. For this type of VoD, it is necessary to have available very wide band networks with a return path and very low latency in order to provide a high quality service.

In the “Pull VoD” type of service, the user selects a content, buys it and requests downloading of the content selected from a remote provider server. Once downloaded by the decoder, the content is stored locally by the decoder, prior to be visualized. For this type of VoD, it is necessary to have available wide band networks with a return path and the decoder must have storage space corresponding to the downloaded content.

In the “Push” type VoD service, an operator makes a selection of the content and “pushes” the entire content via a broadcasting network to all decoders in which the content is then stored. At any moment, the user can choose one of the contents and watches it, if he has the right to do it, for example, if he has a subscription which gives him access to the chosen content, or if he has bought it in advance. A classical unidirectional broadcasting network can be used and the current technologies permit to the decoders to have large storage capacity.

However, in the current VoD systems of the “Push” type, it is difficult to take into account in the decoders the evolutions regarding the programs already stored or to define new types and new structures of the programs.

To this effect, according to a first aspect, the object of the invention is a transmission method of the abovementioned type, wherein the stream comprises a first program unit, which contains a first unit identifier and a first audio/video content, a second program unit, which contains a second unit identifier and a second audio/video content, and a third program unit comprising a third unit identifier and, in addition, containing a list with at least the first unit identifier and the second unit identifier, according to which, when the decoder receives a command for playing the third program unit, the decoder proceeds to displaying on the screen the first and second audio/video contents comprised in the first and second program units, depending on the data present in the first metadata field of the third program unit.

In these embodiments, the transmission method according to the invention comprises, in addition, one or several of the following characteristics:

the first field of metadata of the third program unit provides at least one parameter value indicating that:
the successive playing of the first and second audio/video contents is a loop playback or a unitary playback; and/or
the order is random or not;

in the list in the third program unit, at least one corresponding code is associated with the first unit identifier, one corresponding code is associated with the second unit identifier, and each one of these codes indicates:
a) a specific, authorized or not, mode of playback between a playback jump or accelerated playback; and/or
b) a mandatory or optional nature of the unit to which the code is associated; and/or
c) a jump of the unit, to which the code is associated, and a specific condition to be verified;
d) an action to be performed, the unit identifier of a program unit that is different from the first, second and third units, and optionally, the identification of a command;
   wherein when the code associated to a unit among the first and second units indicates the case a), the decoder, while playing the audio/video content of the said unit, authorizes or prohibits a playback jump or accelerated playback depending on the value of the said code; and/or
wherein, when the code associated to a unit among the first and second units indicates the case b), the decoder authorizes or prohibits the playing of only one of the audio/video contents among the first and second audio/videos contents, when the other of the audio/video contents is not available; and/or
wherein, when the code associated to a unit among the first and second units indicates the case c), the decoder tests the determined condition and jumps the playing when the condition is verified; and/or
wherein, when the code associated to a unit among the first and second units indicates the case d), the decoder performs an action in relation to the other identified program unit, optionally under the condition of reception of the identified command;

when the code associated to a unit among the first and second units indicates the case c), the determined condition is based on:
the availability of the other unit among the first and second units; and/or
a selection already made by the user of a program unit that is different from the first, second and third units; and/or
an audio/video content of a program unit that is different from the first, second and third units; and/or
the comparison of a predetermined list of geographic zones with a code that identifies the geographic localization of the decoder;

the first program unit includes a fixed image and the list of the third unit includes a duration value corresponding to the identifier of the first unit, and according to which the decoder is set up for displaying, during the playing of the third program unit, the image of the first unit for a duration equal to the said value;

the action comprises the playing or the suppression of the other identified program unit;

the stream includes a fourth program unit which indicates an identifier of a program unit that is different from the fourth program unit; and
wherein the decoder, as a result of the reception of the said fourth program unit, replaces the metadata in the first field of the program unit that is different from the fourth program unit by the metadata comprised in the fourth program unit;

the stream includes a suppression command, which indicates a program unit and wherein the decoder suppresses the so defined unit after receiving the said command; and/or wherein the stream includes a suppression command, which indicates a determined date, and wherein the decoder suppresses the memorized program units indicating a date that precedes the determined date;

the first field of metadata of the program units contains a sub-field indicating a “visible” or “hidden” character; and wherein the decoder displays in a program menu information from the first sub-field only for the units containing a sub-field indicating a “visible” character;

upon the selection of a zone presenting on the screen information related to a program unit, the decoder displays on the screen the audio/video content comprised in the said program unit;

the first field of metadata of the program units contains a sub-field indicating a suppression date; and the decoder suppresses the program units depending on the respective data indicated in the said sub-fields.

According to a second aspect, the object of the invention is a decoder set to receive “Push” type video on demand programs and suited for being connected to a display screen; the said decoder contains a memory and means for reception from a broadcasting network a stream containing “Push” type video on demand program units, with each program unit comprising at least a first corresponding field of metadata containing a unit identifier and, optionally, a second field comprising an audio/video content, with the decoder having been set up to store the said program units; the said decoder being suited, while receiving a command for playing a third program unit, the stream containing a first program unit comprising a first unit identifier and a first audio/video content, a second program unit comprising a second unit identifier and a second audio/video content, and a third program unit comprising a third unit identifier and, in addition, comprising a list containing at least the first unit identifier and the second unit identifier, for commanding the successive display on the screen of the first and second audio/video contents included the first and second program units, depending on the data present in the first field of metadata of the third program unit.

### BRIEF DESCRIPTION OF THE DRAWINGS

The invention will be better understood by reading the following description and examining the figures that accompany it. These figures are provided by way of illustration, but they do not limit the invention in any way. The figures are as follows:

FIG. 1 presents a view of a system in an implementation mode of the invention; and

FIG. 2 presents a view of a VoD unit comprising a playlist.

### DETAILED DESCRIPTION

In one embodiment, a video on demand system requires the participation of several participants, among them:

providers of audiovisual contents,

technical operator who prepares, on the basis of the audiovisual contents, metadata associated to each one of these audiovisual contents, and who produces, based on each content and on the associated metadata, a VoD unit, codes the set of VoD units, and prepares the stream to be distributed, which contains these VoD units,

the broadcasting operator, who is in charge of the broadcasting of the stream, the users owners of decoders.

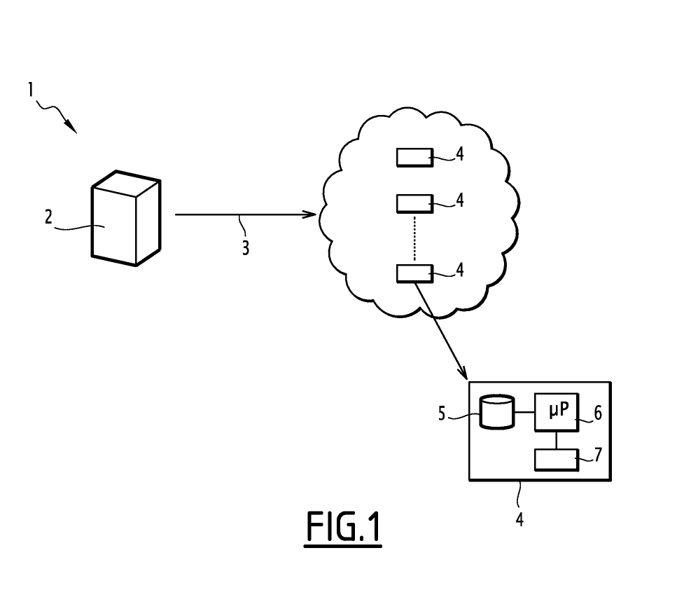

In reference to FIG. 1, a system 1 of Push type video on demand is considered in a simplified representation, in which a server 2 is set up for the creation of the elements of the video on demand and their broadcasting, via a broadcasting network 3, under the form of a stream containing the VoD broadcasting files and, as the case may be, including, in addition, current TV broadcasting programs, to the users of the decoders 4.

The broadcasting network 3 can be, for example, a network for broadcasting of digital television of the MPEG or DVB types. In the present case, the broadcasting network 3 is a network for digital video broadcasting.

Each one of the decoders 4 contains a hard drive 5 for data storage, a microprocessor 6 and a smart card 7. They are designed to receive the stream, to extract the VoD units from the VoD broadcasting files, store the VoD units on the hard drive 5, and then to treat them in a way to make visualized on a display screen the information related to the audio/video contents present in the VoD units and/or the contents themselves.

The display screen is, for example, a TV screen connected to the decoder 4. The metadata are stored uncoded in a database on the hard drive 5 in correspondence with an identifier of the VoD unit to which they belong. In some cases, a content of audio, video or image type, which is present in a VoD unit, is stored in encrypted form on the hard drive and can be played or displayed, i.e. decrypted, and then restored on the screen only if it has been bought by the user of the decoder 4.

It should be noted that some audio, video or image contents, present in a VoD unit, are not in encrypted form and a freely accessible by the used, for example, contents related to trailers, film posters, commercial images or audios/videos . . .

The purchase can be performed in different ways, for example, by subscription and/or online and/or off line transaction.

Once the purchase has been completed, the decoder 4 receives authorization and stores it on the smart card 7, which permits the activation of the decryption by the decoder.

The decoder 4 is designed to determine, depending on the metadata of the VoD units, menus offering the contents of the available VoD units stored on the hard drive 5 after the broadcasting in the “Push” mode, and to display these menus on a screen connected to the decoder.

On a display screen, menus can appear, which are organized, for example, by subject (films, documentaries, children, sport, etc.), offering contents that can be purchased by the user, as well as zones in which, automatically, without selection by the user, audio/video contents are played and/or images are displayed: for example, trailers, commercials, film posters . . .

In addition, the decoder 4 is adapted to play/display then on the screen a content that is present or referenced in a VoD unit corresponding to the selection of the user in a menu (and after verification by the decoder of the access rights, including namely the verification on the smart card 7 of the authorization corresponding to the user).

The service of downloading of Push type VoD content can be active permanently or during predetermined time windows, or also depending on the bandwidth that is currently available on the broadcasting network 3. In one embodiment, the decoders are dynamically informed about the broadcasting periods by means of commands received through the network 3 and are adjusted to monitor the reception of the VoD units only during these periods.

The downloading file of one VoD unit, containing the audio/video, is voluminous, typically several gigabytes. The downloading file of one VoD unit, containing only the metadata, is typically several megabytes.

In the described embodiment of the invention, a VoD unit except the VoD units containing only metadata and not containing image or audio/video or a playlist, contains an element defining a content directly or indirectly, for example, a film, documentary, etc. In one embodiment, such a VoD unit is of “atomic” nature, i.e. if it is not stored entirely or on the basis of a determined parameterizable quality threshold on the hard drive, it is considered unavailable in the menus and its content cannot be played.

A VoD unit is defined uniquely by a VoD unit identifier, for example, a number coded on 32 bits.

One VoD unit comprises, along with its identifier,
a dynamic content, which can be played/displayed, containing:
   an audio/video sequence, or
   a playlist comprising an ordered list of identifiers of other VoD units;
a static content, which can be displayed at least partially, containing:
   an image or a set of images and/or
   a set of metadata.

In one embodiment, the dynamic content comprises one and only one audio/video sequence or one playlist, but not both, so that the command for playing the VoD is not ambiguous.

One audio/video sequence comprises one video track and/or a certain number of tracks and subtitles.

A VoD unit may not contain dynamic content, but only static content with an image of a background type or an image of a commercial, which could, for example, be used as a background image to display menus on the screen.

A VoD unit may contain neither dynamic content nor image.

The VoD unit contains obligatorily a set of metadata. The only element that is necessary in the metadata of the VoD unit is the identifier of the VoD unit. In one embodiment, an identifier of a VOD unit is not modifiable.

Some of the metadata are of information nature, to be displayed on the screen. Other metadata have a technical impact on the life of the VoD unit.

The metadata can be classified into several categories and sub-categories and can comprise:
editorial information related to the content: title, description, participants, producer, production date, chapters, etc.
classification information, for example, function of the local laws: parental control, minimum age, classification of the content, etc.
commercial information: purchase price of a VoD unit, link to the commercial batches of which the VoD element is a part, etc.
technical information:
   “visible” or “hidden” character (depending on the indicated character, the decoder will make the VoD unit explicitly visible and selectable in the menus of the decoder intended or not intended for the user; the “hidden” VoD units are object of references and, therefore, they can not be selected directly by the user: simple images, banner ads, etc.);
   duration of the playing, audio/video format;
   suppression date (the decoder will suppress the VoD unit at a determined moment based on this date);
   identification of the provider of the content; and
   settlement dates of the broadcasting of the VoD unit to the decoder, a minimum acceptable quality of the downloading.
references to other VoD units (for example, when the current VoD unit is the preview of one or other(s) VoD units).
access control: Identification of the required subscription type, as the case may be, or indication that a separate purchase is necessary; additional technical access criteria.
usage control:
   time window authorized for the purchase or selection of the VoD unit (the decoder 4 is set up to authorize the purchase or the selection of this unit only during this time window;
   maximum duration of the making the VoD unit available for reproduction, and/or the maximum number of authorized reproductions (the decoder 4 is set up stop providing the units in the menus and/or the zones of the screen if these maximum thresholds are exceeded); and
   expiration date (the decoder 4 is set up to stop providing the unit in the menus and/or the zones of the screen if the expiration date has been exceeded).

In one embodiment, the decoder 4 for a “visible” VoD unit of the audio/video type, for example, containing an audio/video sequence (a film) and an image (for example, the film poster), is set for displaying in menus editorial and classification information as well as the image. After the user has selected this VoD unit from this display, the decoder processes the audio/video content of the VoD unit in order to restitute it on the screen, depending on access control verifications, etc.

In one embodiment, the metadata of a VoD unit take the form of an XML file, in which each different type of information is identified by a respective identifier similar from one VoD unit to the other (for example, the value of the maximum duration will be provided in all VoD units on the basis of a field identification tag).

As indicated above, instead of carrying the audio/video content, a VoD unit can contain a playlist of the VoD unit(s) from one or the other. The playing of such a VoD unit of the list reproduction type means to play the content identified by each entry in the list. An entry in the list contains the identifier of another VoD unit and the specification of the content to be reproduced/displayed in another unit. This constitutes a mechanism for creating on the screen of dynamic banners of commercials, announcement banners, etc.

When a playlist references an image of another VoD unit, the playlist indicates, in addition, the duration of the display of the image.

For example, a playlist is defined as follows:
display the image “commercial” of VoD unit 101 for 5 seconds;
display the image “commercial” of VoD unit 102 for 3 seconds;
display the dynamic content of VoD unit 103 (the duration here depends actually on the content).

During the restitution of such a VoD unit, the decoder 4 is set up, in accordance with its characteristics indicated in the VoD unit, to display the image “commercial” of VoD unit 101 for 5 seconds; to display the image “commercial” of VoD unit 102 for 3 seconds; and to display the image “commercial” of VoD unit 103, in this order or in another order (see below).

When a VoD unit of the list type is transmitted to a decoder 4 and is stored there, it is possible that at least one of the VoD units referenced in the list has not yet been broadcast.

By the way, the same VoD unit can be referenced in several playlists.

The metadata of a VoD unit of the playlist type can contain, in addition, the following characteristics indicated in the fields of the XML file which are assigned to them, respectively:
“Loop” (for example, when the value 1 is assigned to the field corresponding to the tag “loop”): In this case, when the last VoD unit of the list has been played/displayed, the decoder 4 restarts the reproduction from the first unit (otherwise if this characteristic “loop” has not been selected, i.e. when the value 0 is assigned to the field corresponding to the tag “loop”: the reproduction is discontinued).
“Random order”: Instead of playing sequentially the content of each VoD unit of the playlist in the order of the list, the content of each VoD unit is read once by the decoder 4 in a random order before terminating the playing (or to reiterate it if the characteristic loop is indicated).

In addition, in the VoD unit of the playlist type, the following particularities can be indicated or not indicated with respect to each entry in the playlist, for example, by indicating the determined codes in the specific fields:
The special play modes, i.e. the plays different than the play at a normal speed of a video content (fast play forward, jumps, etc; “trick-mode” in English), are permitted/forbidden: for example, in the case of a playlist containing two entries related to videos of a commercials type and a movie, it can be indicated that the normal play mode is not modifiable for the videos of a commercials type, but that it is modifiable for the film. Thus the commands of the user of decoder 4 will be taken into account by the decoder 4 only during the play of the movie, but not during the play of the videos of the commercials type.
The listed VoD units can be indicated as mandatory items or as optional ones. Thus, when a VoD unit of the playlist type is distributed and stored in the decoder, since the VoD units included in this list and indicated as mandatory are not stored in the decoder, the playlist is considered unavailable by the decoder 4. On the other hand, if only the VoD units indicated as optional are missing, the list can be played by the decoder 4, by omitting the missing units. Thus, in a playlist, which contains a reference, indicated mandatory, to the film of another VoD unit and a reference, indicated optional, to a commercials sequence of still another VoD unit, the playlist will be accessible to the user through the menu even if the VoD unit containing the commercials sequence has not yet been downloaded to the decoder.
Jump over an entry if another entry is missing. For example, in a playlist of the trailer type, at least one entry is a movie trailer, while the other entries are commercials. Therefore, it can be possible not to distribute the entries of commercials if the trailer is missing.
Jump over an entry if another entry is present.
Jump over an entry if another VoD unit has already been played and/or purchased by the user. In a playlist of the trailer type, if the VoD unit containing the movie corresponding to one of the trailers indicated in the list has already been played by the user, it is not necessary to play the trailer.
Jump over an entry if another VoD unit has not already been played and/or purchased by the user.
Jump over an entry if another VoD unit does not have a dynamic video content.
Jump over an entry if another VoD unit has a dynamic video content.
Play the entry only if the geographic code of the zone of the user (who may be known by the decoder, for example, by reading the smart card 7) is in a predefined list of codes.
Do not play the entry if the geographic code of the zone of the user is in a predefined list of codes.
Perform an action on another VoD unit when, after a certain entry of the playlist has been played, the user presses a specific button on the decoder, for example the one for downloading, or selects a specific command on the screen. For example, when a playlist containing the entries corresponding to the VoD units of the trailers and the commercials has been played, the user can select the delivery of the movie (via the VoD unit containing the respective content) simply by selecting a special button during the broadcasting of the trailer of this film. Different actions can be triggered on the basis of the same entry of the list by selecting two different predetermined buttons. Thus, in the playlist, it is determined for a determined entry:
   in a field corresponding to the action, which action must be performed (playing a VoD unit, purchase),
   in a field corresponding to the identification of a VoD unit, it is indicated to which VoD unit, designated by its identifier, this action must be applied, and
   in a field corresponding to the button, if nothing has been indicated, this means that the action is performed for any button; if a particular button has been specified, the action will be performed only if the particular button has been pressed.

Such playlists permit to define in a flexible and evolutive manner interactions and services of VoD without having to modify the software of the decoder.

A stream of VoD units in Push mode can contain VoD units with dynamic content and/or VoD units which contain only images and/or metadata. The latter ones can be the so-called update VoD, which are distributed with the purpose of updating certain or all metadata (in addition to those related to the access control) and/or images of other VoD units that have already been broadcast and stored in the decoders. They are called sequences for updating other VoD units.

Update sequences comprise VoD units which do not contain audio/video contents but only metadata accompanied or not by images and/or commands intended for the decoders 4.

These commands contain, for example, the command for:
suppression of a certain number of VoD units assigned by means of their identifier;
suppression of VoD units which are older than a date specified in the command;
setting up a base audio track in a specific context such as a menu, the command specifying thereby the identifier of the VoD unit containing the audio track and specifying also the identifier of the context, for example of the respective menu. If no menu has been specified, the audio track will be retained as background music played during the display of all menus by the decoders 4;
setting up a background image in a specific context such as a menu, the command specifying thereby the identifier of the VoD unit containing the image and specifying the identifier of the context, for example of the respective menu. if no menu has been specified, the image will be retained as a background image during the display of all menus by the decoders 4;
setting up a current playlist in a specific context, the command specifying thereby the identifier of the VoD unit containing the playlist and specifying the identifier of the context, for example, a bar in the screen reserved to trailers or commercials, next to the portion of the screen reserved for the display of the menus offering the selectable contents.

The decoder 4 is set up for treating the VoD units and play/display the contained audiovisual content (or to which it is referenced in the case of a playlist) depending on the information and the constraints stipulated in the metadata of these VoD units.

For example, if the quality of the downloading evaluated by the decoder is lower than the threshold of the minimum quality of the downloading indicated in the metadata of a VoD unit, then the VoD unit is considered as unavailable by the decoder.

In one embodiment, it is possible that the broadcasting file of a VoD unit is sent and received several times by a decoder 4. The latter is set up to reconstruct the content of the VoD unit from these multiple broadcastings, which is useful when there are transmission errors in different areas of each broadcasting.

In one embodiment, the metadata of a VoD unit are transmitted several times in the form of a sequence for updating the metadata, in order to limit the risk of error in the metadata of the VoD units.

In one embodiment, for example, the decoder 4 is set up to suppress all VoD units whose suppression date provided in the metadata is strictly below the current date.

A VoD unit can be accessible freely in the menu or accessible only to the decoder users who have subscribed to a particular subscription and/or accessible as a result of the purchase of the unit itself. These modalities defined by the operator are specified in the metadata (the “access control” part).

The identification of a subscription made by the user is registered in the smart card 7 of the decoder 4. Likewise, when a user buys a VoD unit, a corresponding authorization in the form, for example, of a session number identifying the VoD unit is registered in the smart card 7. Therefore, when the user selects from the displayed menu a VoD unit, which is not freely accessible, the decoder compares the modalities for access to the VoD unit, defined in the metadata, to the information stored in the smart card and plays/displays the selected content only if there is a correspondence. In one embodiment, the audio/video content of the VoD unit, which is transmitted over the broadcasting network, is stored in the decoder 4 in encrypted form, and it is decrypted by the decoder 4 with the help of at least one key stored in the smart card only if there is a match.

In one embodiment, the metadata related to the access control can not be updated through the reception by the decoder of the sequences for updating the metadata. Thus, once the encrypted audio/video content has been sent to the decoders, it is not possible anymore to modify the criteria for access to the content. In order to do that, the content must be re-encrypted according to the new access criteria and sent to all decoders as a new VoD unit.

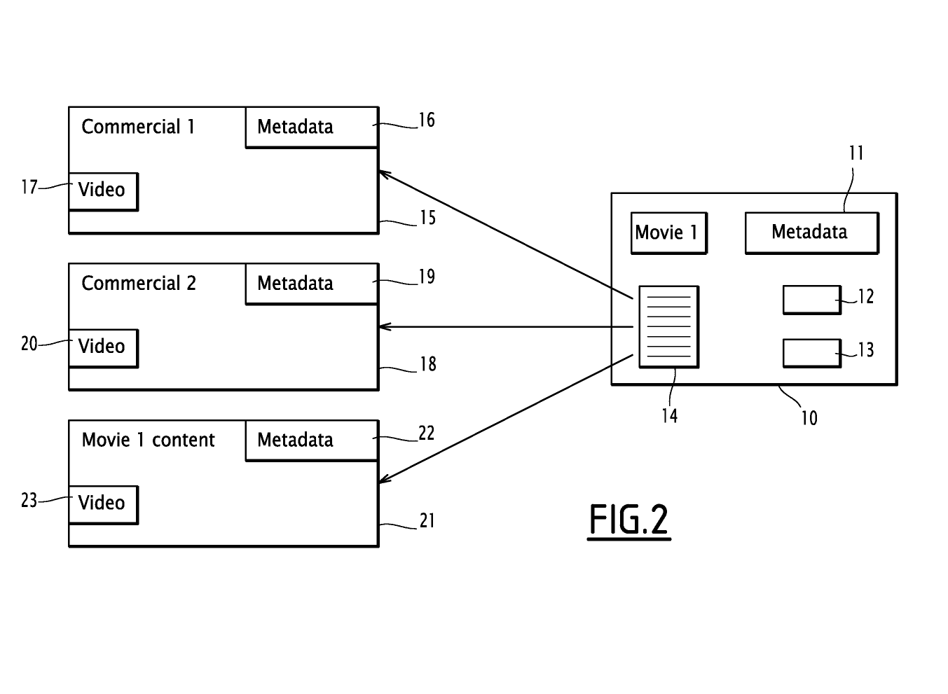

The creation of the VoD units is described in a reference to FIG. 2.

A video unit 21 “Movie 1 content” is created. It contains the audio/video content 23 of a movie named “movie 1” and metadata 22.

These metadata contain different necessary information, including a unique identifier and information, which define that the video unit is “hidden” from the menu of the decoders.

A VoD unit 15 “commercial 1” is created. It contains the audio/video content 17 of the video of a commercial and the metadata 16 containing different necessary information, including a unique identifier and information, which defines that the video unit 15 is “hidden” from the menus of the decoders.

A VoD unit 18 “commercial 2” is created. It contains the audio/video content 20 of the video of a commercial and the metadata 19 containing different necessary information, including a unique identifier and information, which defines that the video unit 18 is “hidden” from the menus of the decoders.

A VoD unit 10 “Movie 1” is created. It contains a playlist 14 and metadata 11 containing different necessary information, including a unique identifier and information, which define that the video unit 10 is “visible” in the menus of the decoders, as well as editorial information on the film 1.

The playlist 14 comprises three entries.

The first entry contains the identifier of the VoD unit 15 “commercial 1”, the specification of the element to be played, which is video 17, in this VoD unit, the “trick-mode forbidden” characteristic and the “ item optional” characteristic.

The second entry contains the identifier of the VoD unit 18 “commercial 2”, the specification of the element to be played here, which is video 20, the “trick-mode forbidden” characteristic and the “ item optional” characteristic.

The third entry contains the identifier of the VoD unit 21 “Movie 1 content”, the specification of the element to be played here, which is video 23, the “trick-mode authorized” characteristic and the “ item obligatory” characteristic.

Thus, in the menu of the contents, which can be visualized and selected, offered by the decoder 4 to the user, only the VoD 10 unit will be visible, but not the VoD units 15, 18, 21.

The VoD unit 10 will be made visualizable by the decoder even if the VoD units 15 and/or 18 are not available provided that the VoD unit 21 is available.

Available means, namely, that the VoD unit is stored by the decoder with a quality of the loading considered satisfactory.

If the user provides to the decoder a command for selection of this unit 10 from the menu presenting the unit and displaying, for example, certain of the editorial pieces of information, then the decoder will display video 17, then video 20, and then video 23.

The decoder will not authorize a jump or the fast play of the videos 17 and 20, but it will authorize this for video 23.

In the menu offered by a decoder depending on the received VoD units, a program of trailers appears in one embodiment.

Let use assume that in week 1 the promotion of two trailers BA1 and BA2 is made in this program, and that in week 2, the promotion of the trailer BA2 and another trailer BA3 is made.

Before week 1, the VoD unit “movie 1” containing the audio/video content of the movie “movie 1” corresponding to the trailer BA1, the VoD unit “BA1” containing the audio/video content of the trailer of the movie “movie 1”, the VoD unit “movie 2” containing the audio/video content of the movie “movie 2” corresponding to the trailer BA2 and the VoD unit “BA2” containing the audio/video content of the trailer of the movie “movie 2” have been broadcasted to the decoders 4.

A VoD unit “program of trailers 1” is also broadcasted.

It contains a playlist with a “loop” characteristic on the entries i defined in the following way in the list, with i=1 to 2:
Identifier of the VoD unit: BAi,
element to be played: audio/video content of the trailer of the movie “movie i”,
“trick-mode forbidden”,
play only if the VoD unit “movie i” is available,
play only if the VoD unit “movie i” has not been already selected and/or bought by the user.

At the beginning of week 1, a command is transmitted to the decoders via the network 3 ordering them to offer in their menus the trailers program corresponding to the VoD unit “program of trailers 1”.

During week 1, a VoD unit “program of trailers 2” is also broadcasted, as well as the VoD unit “movie 3” containing the audio/video content of the movie “movie 3” corresponding to the trailer BA3 and the VoD unit “BA3” containing the audio/video content of the trailer of the movie “movie 3”.

A VoD unit “program of trailers 2” is also broadcasted.

It contains a playlist with a “loop” characteristic on the entries i defined in the following way in the list, with i=2 to 3:
Identifier of the VoD unit: BAi,
element to be played: audio/video content of the trailer of the movie “movie i”,
“trick-mode forbidden”,
play only if the VoD unit “movie i” is available,
play only if the VoD unit “movie i” has not been already selected and/or bought.

In another embodiment, by replacing the trailers with images, it is possible to create a promotion program for the films with the help of one VoD unit of the playlist type referring to the VoD units containing movie images.

1-22. (canceled)

23. Transmission method for Push type video on demand programs comprising the following steps:
transmitting a broadcasting stream of Push type video on demand program units is transmitted from a remote server over a broadcasting network to multiple decoders, connectable to display screens, with each program unit comprising at least a first corresponding metadata field containing a unit identifier and, optionally, a second field with audio/video content,
storing the program units in the memory of each decoder;
wherein the stream contains a first program unit comprising a first unit identifier and a first audio/video content, a second program unit comprising a second unit identifier and a second audio/video content, and a third program unit comprising a third unit identifier and also comprising, in addition, a list containing at least the first unit identifier and the second unit identifier; and
wherein, when the decoder receives a command for playing the third program unit, it proceeds to displaying on the screen successively the first and the second audio/video contents comprised in the first and the second program units, depending on the data present in the first field of metadata of the third program unit.

24. Transmission method according to claim 23, wherein the first field of metadata of the third program unit provides at least one parameter value indicating that:
the successive playing of the first and second audio/video contents is a loop playback or a unitary playback; and/or
the order of playing is random or not.

25. Transmission method according to claim 23, wherein the list of the third program unit at least one respective code is associated with the first unit identifier and/or one respective code is associated with the second unit identifier, with each one of these codes indicating:
a) a specific, authorized or not, mode of playback between a playback jump or accelerated playback; and/or
b) a mandatory or optional nature of the unit to which the code is associated; and/or
c) a jump of the unit, to which the code is associated, and a specific condition to be verified;
d) an action to be performed, the unit identifier of a program unit that is different from the first, second and third units, and optionally, the identification of a command;
wherein when the code associated to a unit among the first and second units indicates the case a), the decoder, while playing the audio/video content of the said unit, authorizes or prohibits a playback jump or accelerated playback depending on the value of the said code; and/or
wherein, when the code associated to a unit among the first and second units indicates the case b), the decoder authorizes or prohibits the playing of only one of the audio/video contents among the first and second audio/videos contents, when the other of the audio/video contents is not available; and/or
wherein, when the code associated to a unit among the first and second units indicates the case c), the decoder tests the determined condition and jumps the playing when the condition is verified; and/or
wherein, when the code associated to a unit among the first and second units indicates the case d), the decoder performs an action in relation to the other identified program unit, optionally under the condition of reception of the identified command.

26. Transmission method according to claim 25, wherein when the code associated to a unit among the first and second units indicates the case c), the determined condition is based on:
the availability of the other unit among the first and second units; and/or
a selection already made by the user of a program unit that is different from the first, second and third units; and/or
an audio/video content of a program unit that is different from the first, second and third units; and/or
the comparison of a predetermined list of geographic zones with a code that identifies the geographic localization of the decoder.

27. Transmission method according to claim 23, wherein the first program unit includes a fixed image and the list of the third unit includes a duration value corresponding to the identifier of the first unit, and wherein the decoder is set up for displaying, during the playing of the third program unit, the image of the first unit for a duration equal to the said value.

28. Transmission method according to claim 25, wherein the action comprises the playing or the suppression of the other identified program unit.

29. Transmission method according to claim 26, wherein the action comprises the playing or the suppression of the other identified program unit.

30. Transmission method according to claim 23, wherein the stream includes a fourth program unit which indicates an identifier of a program unit that is different from the fourth program unit; and
wherein the decoder, as a result of the reception of the said fourth program unit, replaces the metadata in the first field of the said program unit that is different from the fourth program unit by the metadata comprised in the fourth program unit.

31. Transmission method according to claim 23, wherein the stream includes a suppression command indicating an identifier of a program unit, wherein the decoder suppresses the unit so identified upon the reception of the said command; and/or
wherein the stream contains a suppression command indicating a determined date, and the decoder suppresses the memorized program units indicating a date preceding the determined date.

32. Transmission method according to claim 23, wherein the first field of metadata of the program units contains a sub-field indicating a “visible” or “hidden” character; and the decoder displays in a program menu information from the first sub-field only for the units containing a sub-field indicating a “visible” character.

33. Transmission method according to claim 32, wherein upon the selection of a zone presenting on the screen information related to a program unit, the decoder displays on the screen the audio/video content comprised in the said program unit.

34. Transmission method according to claim 23, wherein the first field of metadata of the program units contains a sub-field indicating a suppression date; and the decoder suppresses the program units depending on the respective data indicated in the said sub-fields.

35. Decoder set up to receive Push type video on demand programs and capable to be connected to a display screen; the said decoder contains a memory and means for reception from a broadcasting network of a stream containing “Push” type video on demand program units, with each program unit comprising at least a first corresponding field of metadata containing a unit identifier and, optionally, a second field comprising an audio/video content, with the decoder being adapted for storing the said program units; the said decoder being adapted, while receiving a command for playing a third program unit, the stream containing a first program unit comprising a first unit identifier and a first audio/video content, a second program unit comprising a second unit identifier and a second audio/video content, and a third program unit comprising a third unit identifier and, in addition, comprising a list containing at least the first unit identifier and the second unit identifier for commanding the successive display on the screen of the first and second audio/video contents included the first and second program units, depending on the data present in the first field of metadata of the third program unit.

36. Decoder according to claim 35, adapted for, depending on the parameter value in the first field of metadata of the third program unit:
playing successively the first and the second audio/video contents in a loop or only once; and/or
using an order of playing of the first and the second audio/video contents randomly or not randomly.

37. Decoder according to claim 35, adapted for determining in the list in the third program unit at least one value of a corresponding code associated with the first unit identifier and/or at least one corresponding code associated with the second unit identifier, the decoder being adapted for:
depending on the value of the said determined code, authorizing or forbidding a playback jump or accelerated playback during the playing of the audio/video content of the said unit; and/or
depending on the value of the said determined code, authorizing or forbidding the playing of only one of the audio/video contents among the first and second audio/video contents when the other of the audio/video contents is not available; and/or
depending on the function of the value of the said determined code, testing a determined condition and jump the playing of the unit when the condition has been verified; and/or
depending on the function of the value of the said determined code, performing an action relatively to the other program unit identified by the said value, optionally under the condition of reception of a command identified by the said value.

38. Decoder according to claim 36, adapted for determining in the list in the third program unit at least one value of a corresponding code associated with the first unit identifier and/or at least one corresponding code associated with the second unit identifier, the decoder being adapted for:
depending on the value of the said determined code, authorizing or forbidding a playback jump or accelerated playback during the playing of the audio/video content of the said unit; and/or
depending on the value of the said determined code, authorizing or forbidding the playing of only one of the audio/video contents among the first and second audio/video contents when the other of the audio/video contents is not available; and/or
depending on the function of the value of the said determined code, testing a determined condition and jump the playing of the unit when the condition has been verified; and/or
depending on the function of the value of the said determined code, performing an action relatively to the other program unit identified by the said value, optionally under the condition of reception of a command identified by the said value.

39. Decoder according to claim 37, in which the determined condition points to:
the availability of the other unit among the first and second units; and/or
a selection already made by the user of a program unit that is different from the first, second and third units; and/or
an audio/video content of a program unit that is different from the first, second and third units; and/or
the comparison of a predetermined list of geographic zones with a code that identifies the geographic localization of the decoder.

40. Decoder according to claim 38, in which the determined condition points to:
the availability of the other unit among the first and second units; and/or
a selection already made by the user of a program unit that is different from the first, second and third units; and/or
an audio/video content of a program unit that is different from the first, second and third units; and/or
the comparison of a predetermined list of geographic zones with a code that identifies the geographic localization of the decoder.

41. Decoder according to claim 35, adapted for determining, with the first program unit including a fixed image, in the list of the third unit a duration value, corresponding to the identifier of the first unit, and to display, during the playing of the third program unit, the image of the first unit for a duration equal to the said determined value.

42. Decoder according to claim 37, in which the action comprises the playing or the suppression of the other identified program unit.

43. Decoder according to claim 38, in which the action comprises the playing or the suppression of the other identified program unit.

44. Decoder according to claim 35, adapted for replacing, after the reception of a fourth program unit included in the stream and indicating the identifier of a program unit that is different from the fourth program unit, the metadata in the first field of the said program unit that is different from the fourth program unit by the metadata comprised in the fourth program unit.

45. Decoder according to claim 35, adapted upon reception of a suppression command in the stream, indicating a program unit identifier, for suppressing the unit so identified; and/or adapted, upon reception of a suppression command in the stream indicating a determined date, for suppressing the memorized program units indicating a date that is preceding the determined date.

46. Decoder according to any of the claim 35, adapted with the first field of metadata of the program units containing a sub-field indicating a “visible” or “hidden” character, for displaying in a programs-offering menu information from the first sub-field of an unit only after verification that the unit contains a sub-field indicating a “visible” character.

47. Decoder according to claim 46, adapted, after the identification of a selection of a zone presenting on the screen information related to a program unit, for displaying on the screen the audio/video content comprised in the said program unit.

48. Decoder according to claim 35, adapted for determining a suppression date indicated in a sub-field of the first field of metadata of a program unit and for suppressing at least one program unit depending on the determined date.
